(19) United States
(12) Patent Application Publication
(10) Pub. No.: US 2007/0097794 A1
(43) Pub. Date: May 3, 2007

(54) Timepiece with a fan-shaped hand motion display mechanism

(76) Inventor: Shigeo Suzuki, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/586,221

(22) Filed: Oct. 25, 2006

(30) Foreign Application Priority Data
Oct. 27, 2005 (JP) 2005-313291

(51) Int. Cl. G04B 19/24

(52) U.S. Cl. 368/28

(57) ABSTRACT

There is provided a timepiece that has less number of components of a fan-shaped hand-motion display mechanism and provides greater freedom of the position where the fan-shaped hand-motion display mechanism is disposed. The timepiece with a fan-shaped hand-motion display mechanism according to the invention includes a column wheel having a cam outer circumference, a swingable hammer in contact with the cam outer circumference of the column wheel, and a small day indicator that rotates in response to the swing movement of the hammer. The column wheel is configured to rotate, in response to the rotation of a train wheel of the timepiece, in a direction in which the distance between the center of rotation of the column wheel and the contact point between the column wheel and the hammer increases. The center of rotation of the column wheel coincides with the center of rotation of an indicator hand that displays time information.

### BACKGROUND OF THE INVENTION

1. Field of the Invention

The present invention relates to a timepiece with a fan-shaped hand-motion display mechanism that displays information on time, calendar and the like by moving a display member in a fan-shaped motion. The present invention particularly relates to a timepiece with a fan-shaped hand-motion display mechanism including a movement configured such that the position of a retrograde indicator hand that swings in a fan-shaped motion can be arbitrarily selected.

2. Description of the Prior Art

In the structure of a timepiece, particularly a wristwatch with numerous functions, a movement (mechanical body) of the timepiece generally has a main plate that forms the base of the movement. The dial side of the main plate is referred to as the back side of the timepiece, while the opposite side of the main plate to the dial is referred to as the front side of the timepiece. Furthermore, a train wheel assembled on the front side of the timepiece is referred to as a front train wheel, while a train wheel assembled on the back side of the timepiece is referred to as a back train wheel. Since numbers 1 to 12 are often printed along the outer circumference of the dial of the timepiece, directions corresponding to portions along the outer circumference of the timepiece are therefore expressed using these numbers. For example, in the case of a wristwatch, the upward direction and the upper side of the wristwatch are referred to as “twelve o'clock direction” and “twelve o'clock side”, respectively, and the rightward direction and the right side of the wristwatch are referred to as “three o'clock direction” and “three o'clock side”, respectively, and the downward direction and the lower side of the wristwatch are referred to as “six o'clock direction” and “six o'clock side” respectively, and the leftward direction and the left side of the wristwatch are referred to as “nine o'clock direction” and “nine o'clock side”, respectively.

In general, in a wristwatch, a drive module, control module, front train wheel and the like are assembled on the front side of the timepiece, while a calendar module, for example, a date indicator driving portion, date indicator, date corrector, day indicator driving portion, day indicator, day corrector and the like are assembled on the back side of the timepiece. In a wristwatch, a switching portion may be assembled on the front side and/or on the back side of the timepiece. A conventional timepiece with a calendar function has a ring shaped date indicator, on which 31 teeth are provided. Numbers 1 to 31 are printed on the date indicator. The date indicator is rotatably assembled along the outer circumference of the main plate.

In a conventional timepiece with a calendar function, the date indicator is advanced by one tooth per day in response to the rotation of the date indicator driving wheel, while the day indicator is advanced by one tooth per day in response to the rotation of the day indicator driving wheel. One of the numbers on the date indicator, for example, “1”, and one of the characters on the day indicator, for example, “MON”, are visible through windows in the dial. Therefore, the wearer of the timepiece will know from these date and day displays that the date is the first of the month and the day is Monday. The date and day displays are usually located on the three o'clock side or six o'clock side of the timepiece. In a wristwatch that displays date and day by means of hands, for example, the center of rotation of the date indicator coincides with the center of the main plate. The date is displayed by means of date characters provided on the date indicator.

A first structure for conventional fan-shaped hand-motion display (that is, display by means of a “retrograde indicator hand” that swings in a fan-shaped motion) includes an independent motor for this particular hand motion as well as a regular motor for time display. In such a conventional timepiece with a calendar function, a winding stem will be positioned at three click locations; the “zeroth click”, “first click” and “second click.” When the winding stem is pushed against the case of the wristwatch and positioned at the “zeroth click”, the wristwatch is in a “normal state in which the wristwatch is worn”. In this state, for a mechanical timepiece, the wearer can wind the mainspring. When the winding stem is pulled out by one click from the case of the wristwatch and positioned at the “first click”, the wristwatch is in a “first correctable state”. In this state, for a wristwatch with a calendar function, the wearer can correct the date and day displays. When the winding stem is further pulled out and positioned at the “second click”, the wristwatch is in a “second correctable state”. In this state, for a wristwatch with a calendar function, the wearer can correct the time display.

A second structure for conventional fan-shaped hand-motion display includes a column wheel with a cam outer circumference, a swingable hammer in contact with the outer circumference of the column wheel, a small gear that rotates in response to the swinging movement of the hammer, a display member that displays calendar information in response to the rotation of the small gear, an intermediate gear integrally formed with the column wheel, an intermediate gear jumper that regulates the rotation of the intermediate gear, and an intermittent driving member that intermittently rotates the intermediate gear. In this structure, the column wheel is configured to rotate in response to the rotation of the train wheel in a direction in which the distance between the center of rotation of the column wheel and the contact point between the column wheel and the hammer effectively increases. In this structure, the center of rotation of the column wheel is located in an intermediate region between the center of rotation of an hour wheel (i.e., the center of the main plate) and the periphery of the main plate (see the Japanese Patent No. 3,140,700 below, for example).

The first structure for conventional fan-shaped hand-motion display has a problem because it requires the motor for fan-shaped hand-motion, resulting in the increased number of motors and parts that forms the train wheel. Also, in this conventional first structure, since the layout of the plurality of motors and the train wheel driven by those motors is restricted, the position of the day display mechanism cannot be changed as long as the same components of the movement are used.

In the second structure for conventional fan-shaped hand-motion display, since the center of rotation of the column wheel is restricted in the intermediate region between the center of the main plate and the periphery of the main plate, the position of the day display mechanism is dictated by the position of the column wheel as long as the same components of the movement are used. In this conventional second structure, the footprint of the column wheel is also large. Also, in the second structure, since the position where the column wheel is disposed is shifted toward the outer circumference of the movement, it is difficult to reserve an area for efficiently disposing a regular ring-shaped date indicator in the movement without increasing the size of the movement.

An object of the invention is to provide a compact and thin timepiece with a fan-shaped hand-motion display mechanism having less number of components. Another object of the invention is to provide a timepiece with a structure that provides greater freedom of the position where a fan-shaped hand-motion display mechanism is disposed and allows the position of a retrograde indicator hand being arbitrarily selected in the movement. Still another object of the invention is to provide a timepiece with a structure in which a regular ring-shaped date indicator and a fan-shaped hand-motion display mechanism can be efficiently disposed in the movement.

### SUMMARY OF THE INVENTION

A timepiece with a fan-shaped swing and display mechanism according to the invention includes a drive module for driving the timepiece, a control module for controlling the operation of the drive module, a train wheel that rotates based on the operation of the drive module, and a first display member that displays information on time, calendar and the like based on the rotation of the train wheel. The timepiece according to the invention further includes a column wheel having a cam outer circumference that is formed such that the radius from the center of rotation to the outer circumference continuously changes along the circumferential direction from the minimum to the maximum values, the column wheel rotating in response to the rotation of the train wheel, a swingable hammer in contact with the outer circumference of the column wheel, a small gear that rotates in response to the swing movement of the hammer, a second display member that rotates in response to the rotation of the small gear, and a driving member for rotating the column wheel. The column wheel is configured to rotate, in response to the rotation of the train wheel, in a direction in which the distance between the center of rotation of the column wheel and the contact point between the column wheel and the hammer increases. The center of rotation of the column wheel coincides with the center of rotation of the first display member.

In the timepiece of the invention, the column wheel advantageously includes a column wheel gear that is rotated by the driving member and a column wheel jumper that regulates the rotation of the column wheel gear. With such a configuration, the rotation of the column wheel can be reliably regulated. The timepiece of the invention advantageously further includes a hammer return spring configured to apply a rotational force on the hammer in a direction in which the hammer is pressed against the column wheel.

In this configuration, the column wheel disposed at the center of the movement actuates the hammer, and an indicator hand attached to an indicator hand wheel having a gear that engages the gear of the hammer moves, or the small gear, in a fan-shaped region. The small gear engages the gear of the hammer return spring, so that the hammer return spring can return the position of the indicator hand to its initial position. With such a configuration, there can be provided a compact and thin timepiece with a fan-shaped hand-motion display mechanism having less number of components in which the position of a retrograde indicator hand can be arbitrarily selected.

It is advantageous that the timepiece of the invention includes an hour wheel that rotates in response to the rotation of the train wheel to display information on “hour”, and the column wheel is guided around the outer cylindrical circumference of the hour wheel and rotates around the center of rotation of the hour wheel. The timepiece of the invention also includes a date indicator driving wheel that rotates in response to the rotation of the train wheel and is configured such that the small gear is configured as a small day indicator and the column wheel gear makes 1/7 revolution once a day in response to the rotation of the date indicator driving wheel, allowing the display member provided on the small gear to swing in a fan shape to display “day.”

Alternatively, the timepiece of the invention includes a date indicator driving wheel that rotates in response to the rotation of the train wheel and a date indictor that rotates in response to the rotation of the date indicator driving wheel to display information on “date”, and is configured such that the intermittent driving member rotates in response to the rotation of the date indicator driving wheel. This configuration allows the ring-shaped date indicator to display information on “date” and the fan-shaped hand-motion display mechanism to display “day.”

In a timepiece with a fan-shaped swing and display mechanism according to the invention, the movement of the timepiece includes a drive module, a control module, a train wheel, a column wheel, and a driving member for rotating the column wheel. In the timepiece of the invention, the movement is provided with one hammer assembling portion where a swingable hammer in contact with the outer circumference of the column wheel can be assembled and two small gear assembling portions where a small gear that rotates in response to the swing movement of the hammer, so that the hammer is assembled at the hammer assembling portion and the small gear is assembled at one of the two small gear assembling portions. In the timepiece of the invention, the column wheel is configured to rotate, in response to the rotation of the train wheel, in the direction in which the distance between the center of rotation of the column wheel and the contact point between the column wheel and the hammer increases. The timepiece of the invention also includes a first display member that displays information on time, calendar and the like based on the rotation of the train wheel and a second display member that rotates in response to the rotation of the small gear, and the center of rotation of the column wheel coincides with the center of rotation of the first display member.

The timepiece described above is configured such that the movement is provided with a plurality of small gear assembling portions where the small gear that rotates in response to the swing movement of the hammer can be assembled, so that the hammer is assembled at one of the plurality of the hammer assembling portions and the small gear is assembled at one of the small gear assembling portions. With such a configuration, the invention provides a timepiece that has greater freedom of the position where a fan-shaped hand-motion display mechanism is disposed and allows the position of a retrograde indicator hand being arbitrarily selected in the movement.

The timepiece described above also includes a date indicator driving wheel that rotates in response to the rotation of the train wheel and a date indictor that rotates in response to the rotation of the date indicator driving wheel to display information on “date”, and the intermittent driving member is configured to rotate in response to the rotation of the date indicator driving wheel. The center of rotation of the small gear is preferably located between the outer circumference of the column wheel gear and the addendum circle of the day indicator, and the center of rotation of the hammer is preferably located between the outer circumference of the column wheel gear and the addendum circle of the day indicator. In thus configured timepiece of the invention, the regular ring-shaped date indicator and the fan-shaped hand-motion display mechanism can be efficiently disposed in the movement.

### BRIEF DESCRIPTION OF THE SEVERAL VIEWS OF THE DRAWINGS

A preferred form of the present invention is illustrated in the accompanying drawings in which:

FIG. 1 is a schematic plan view showing the configuration of the fan-shaped hand-motion display mechanism in the first embodiment of the timepiece with a fan-shaped hand-motion display mechanism according to the invention;

FIG. 2 is a schematic plan view showing the front side of the movement in the first embodiment of the timepiece with a fan-shaped hand-motion display mechanism according to the invention;

FIG. 3 is a schematic plan view showing the date indicator driving mechanism, date corrector mechanism and day corrector mechanism in the first embodiment of the timepiece with a fan-shaped hand-motion display mechanism according to the invention;

FIG. 4 is schematic cross-sectional view showing the winding stem and day indicator driving mechanism in the first embodiment of the timepiece with a fan-shaped hand-motion display mechanism according to the invention;

FIG. 5 is a schematic cross-sectional view showing the date corrector mechanism and day corrector mechanism in the first embodiment of the timepiece with a fan-shaped hand-motion display mechanism according to the invention;

FIG. 6 is a schematic plan view showing the exterior of the complete assembly of the timepiece in the first embodiment of the time piece with a fan-shaped hand-motion display mechanism according to the invention;

FIG. 7 is a schematic plan view showing the configuration of the fan-shaped hand-motion display mechanism in the first variation of the first embodiment of the timepiece with a fan-shaped hand-motion display mechanism according to the invention.

FIG. 8 is a schematic plan view showing the exterior of the complete assembly of the timepiece in the first variation of the first embodiment of the timepiece with a fan-shaped hand-motion display mechanism according to the invention;

FIG. 9 is a schematic plan view showing the exterior of the complete assembly of the timepiece in the second variation of the first embodiment of the timepiece with a fan-shaped hand-motion display mechanism according to the invention;

FIG. 10 is a schematic plan view showing the configuration on the front side of the movement in the second embodiment of the timepiece with a fan-shaped hand-motion display mechanism according to the invention; and

FIG. 11 is a schematic plan view showing the configuration on the front side of the movement with the train wheel bridge removed in the second embodiment of the timepiece with a fan-shaped hand-motion display mechanism according to the invention.

### DETAILED DESCRIPTION OF THE PREFERRED EMBODIMENTS

Embodiments of the invention will be described below with reference to the drawings.

### (1) First Embodiment

A first embodiment of a timepiece with a fan-shaped hand-motion display mechanism according to the invention will be described below. Although the following description of the embodiment according to the invention is based on an electronic timepiece, the configuration of the timepiece with a fan-shaped hand-motion display mechanism to which the invention is applied is also applicable to timepieces that operate under other principles of operation, such as mechanical timepieces and electrical timepieces. The first embodiment of the invention is an analogue electronic timepiece in which the center of rotation of an indicator hand of the fan-shaped hand-motion display mechanism is located in the five o'clock direction of the movement.

(1.1) Configuration of the Front Side of the Movement

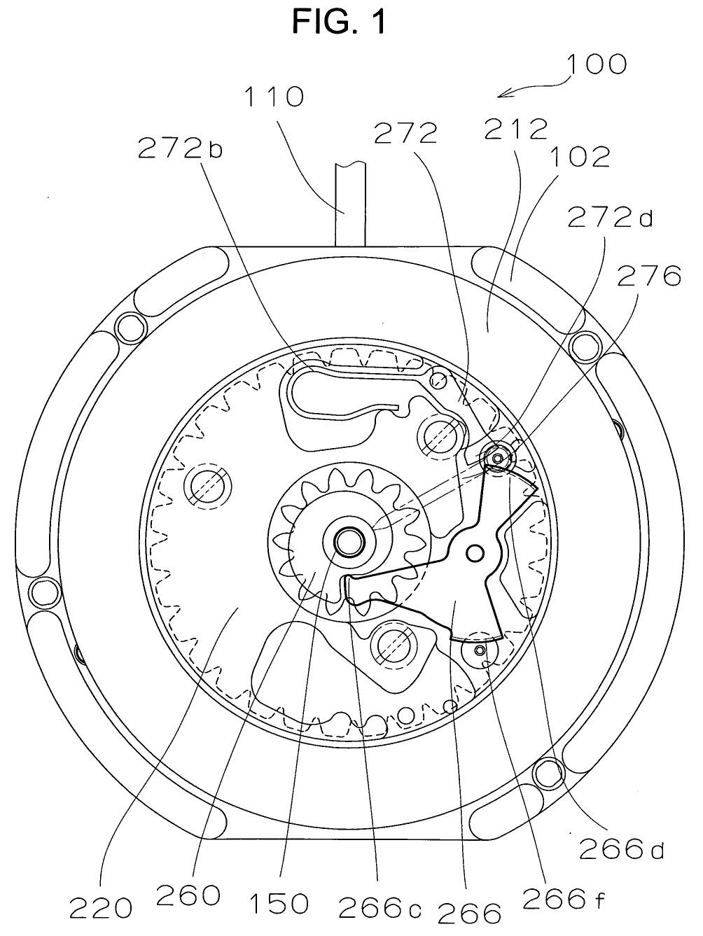

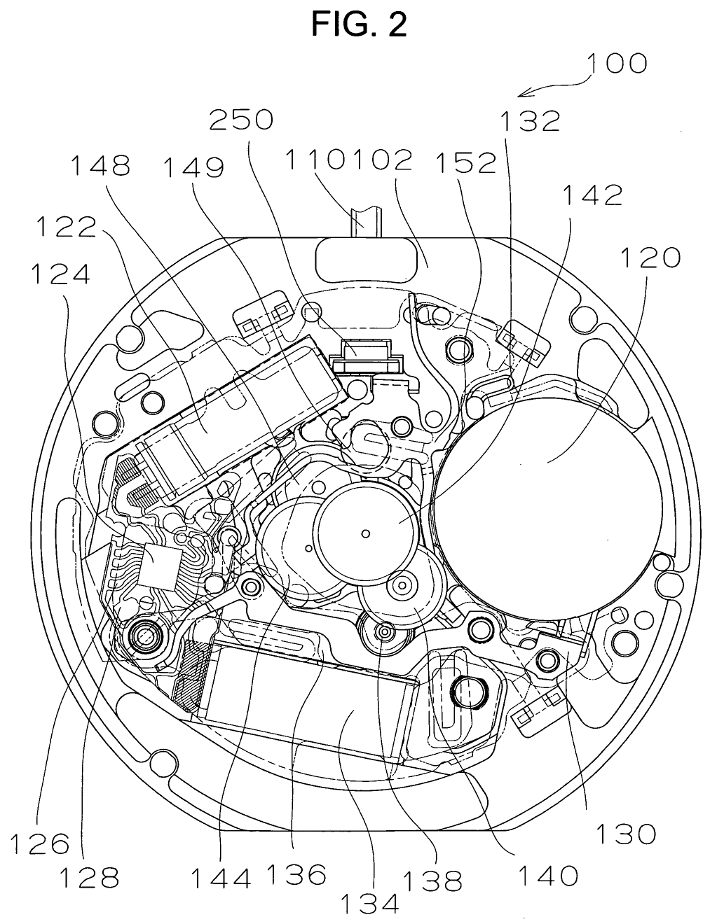

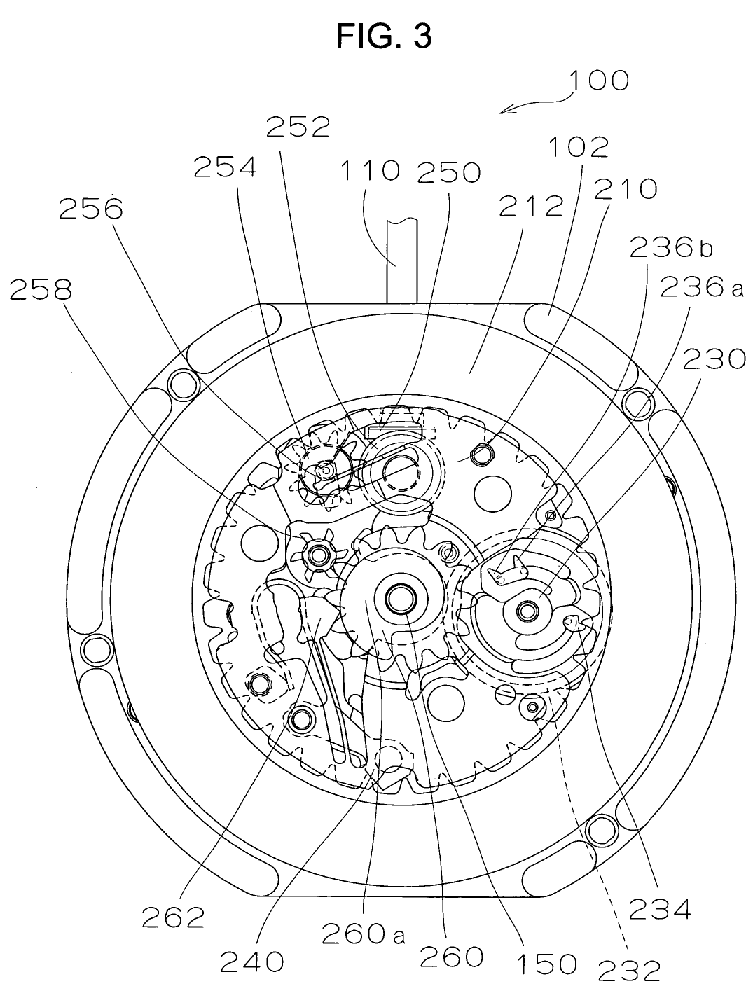

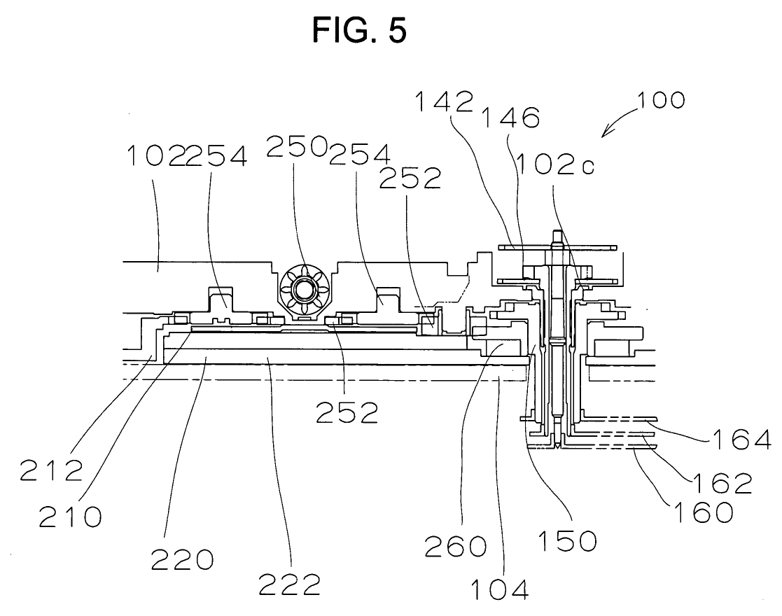

Referring to FIGS. 1 to 5, in the first embodiment of the timepiece with a fan-shaped hand-motion display mechanism according to the invention, a movement 100 includes a main plate 102 that forms a base of the movement 100. A dial 104 is attached to the movement 100. A winding stem 110 is rotatably assembled in the main plate 102. A clutch wheel 112 is disposed such that it shares the same axis of rotation with the winding stem 110. Referring to FIG. 2, on the case back side (the front side) of the main plate 102 are disposed a battery 120 that forms a power source of the timepiece, a crystal oscillator unit 122 that forms an oscillation source of the timepiece, and an integrated circuit (IC) 125 that forms a drive controller of the timepiece. A circuit board 126, the crystal oscillator unit 122 and the integrated circuit 125 form a circuit block 128. The circuit block 126 is disposed on case back side of the main plate 102. A battery connection (−) 130 is provided to electrically connect the cathode of the battery 120 to a negative pattern of the circuit board 126. A battery connection (+) 132 is provided to electrically connect the anode of the battery 120 to a positive pattern of the circuit board 128.

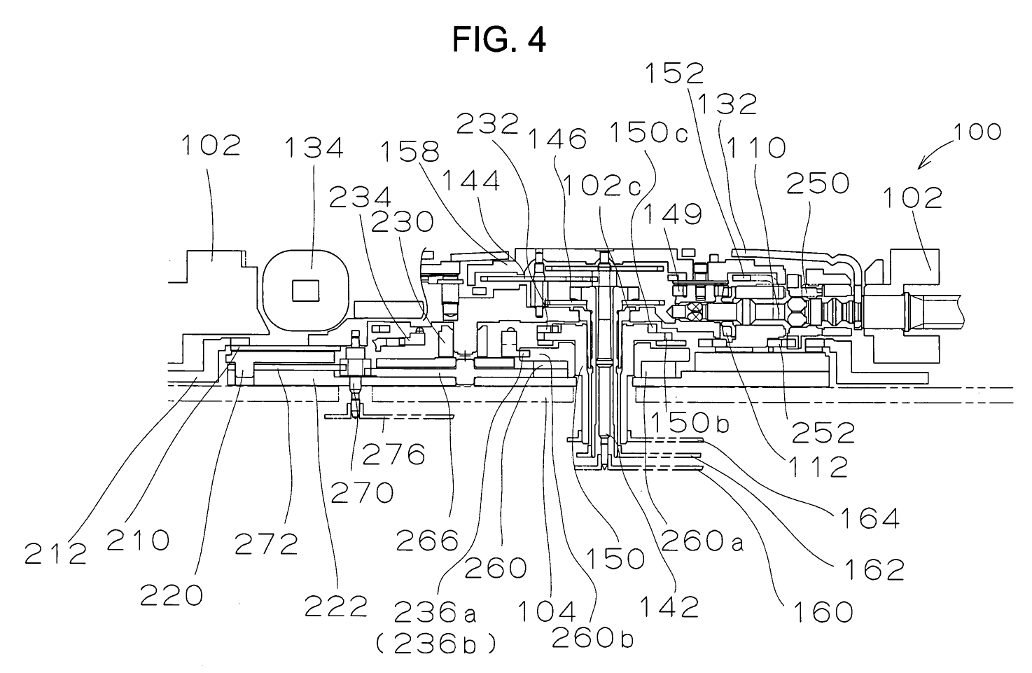

Referring to FIGS. 2 and 4, on the case back side of the main plate 102 are disposed a coil block 134, a stator 136 and a rotor 138 that form a stepper motor. Rotation of the rotor 138 rotates a fifth wheel & pinion 140. Rotation of the fifth wheel & pinion 140 rotates a second wheel & pinion 142. Rotation of the second wheel & pinion 142 rotates a third wheel & pinion 144. Rotation of the third wheel & pinion 144 rotates a center wheel & pinion 146. Rotation of the center wheel & pinion 146 rotates a minute wheel 148. Rotation of the minute wheel 148 rotates an hour wheel 150.

The second wheel & pinion 142 is configured to make one revolution in one minute. A second hand 160 is attached to the second wheel & pinion 142. The center wheel & pinion 146 is configured to make one revolution in one hour. A minute hand 162 is attached to the center wheel 146. A sliding mechanism (not shown) is provided on the center wheel & pinion 146. The sliding mechanism allows the minute hand 162 and hour hand 164 to rotate by rotating the winding stem 110 with the second hand 160 stopped for time setting. A train wheel setting lever 152 is provided to regulate the gear of the fifth wheel & pinion 140 to stop the rotation of the second hand 160: when the winding stem 110 is pulled out to the second click for time setting. A center pipe 102c is fixed to the main plate 102. The center pipe 102c extends from the case back side of the main plate 102 to the dial side of the main plate 102. The center wheel & pinion 146 is rotatably supported in the hole of the center pipe 102c. The abacus bead of the second wheel. & pinion 142 is rotatably supported in the hole of the center wheel & pinion 146.

A train wheel bridge 158 is disposed on the case back side of the main plate 102. The upper part of the shaft of the rotor 138, the upper part of the shaft of the fifth wheel & pinion 140, the upper part of the shaft of the second wheel & pinion 142, the upper part of the shaft of the third wheel & pinion 144, and the upper part of the shaft of the minute wheel 148 are rotatably supported in the train wheel bridge 158. The lower part of the shaft of the rotor 138, the lower part of the shaft of the fifth wheel & pinion 140, the lower part of the shaft of the third wheel & pinion 144, and the lower part of the shaft of the minute wheel 148 are rotatably supported in the main plate 102. The hour wheel 150 is configured to make one revolution in twelve hours. The hour hand 164 is attached to the hour wheel 150. The hour hand 164 attached to the hour wheel 150 displays “hour” in the “twelve-hour system” in which one revolution takes twelve hours. A minute gear of the minute wheel 148 is disposed such that it engages a setting wheel 149. The setting wheel 149 is disposed between the main plate 102 and the train wheel bridge 158. A minute pinion (not shown) of the minute wheel 148 is situated on the dial side of the main plate 102 and configured such that it engages an hour wheel gear of the hour wheel 150. The hole of the hour wheel 150 is rotatably supported on the outer circumferential surface of the shaft of the center pipe 102c. The center of rotation of the hour wheel 150 coincides with the center of rotation of the center wheel & pinion 146. The center of rotation of the hour wheel 150 coincides with the center of rotation of the second wheel & pinion 142. The centers of rotation of the hour wheel 150, the center wheel & pinion 146 and the second wheel & pinion 142 are preferably located at the center of the main plate 102.

(1.2) Configuration of the Back Side of the Movement

Referring to FIGS. 1 and 3 to 5, a date indicator maintaining plate 210 disposed on the back side of the movement is provided to rotatably support a date indicator 212 relative to the main plate 102. A small day indicator support seating 220 is assembled on the dial 104 side of the date indicator maintaining plate 210. A small day indicator support 222 is assembled between the small day indicator support seating 220- and the dial 104. A date indicator driving wheel 230 is rotatably supported on the main plate 102. A date indicator driving wheel 230 includes a date gear 232, a date finger 234, and two column wheel fingers 236a, 236b. Although a configuration in which two column wheel fingers are provided is illustrated and described, one column wheel finger may be used. The hour wheel 150 includes an hour gear 150b that engages the minute pinion (not shown) and a date pinion 150c that engages the date gear 232. The date indicator 212 is assembled such that the date finger 234 intermittently drives the date indicator 212 by 1/31 revolution in 24 hours. A date jumper 240 regulates the rotation of the date indicator 212. The center of rotation of the date indicator 212 substantially coincides with the center of rotation of the hour wheel 150 and both the centers of rotation are preferably located substantially at the center of the main plate 102. The date indicator driving wheel 230 is configured to make one revolution in 24 hours.

A first calendar corrector transfer wheel 250 is assembled such that it is coaxial with the winding stem 110. A second calendar corrector transfer wheel 252 is assembled between the main plate 102 and the date indicator maintaining plate 210. The gear of the first calendar corrector transfer wheel 250 is configured to engage the gear of the second calendar corrector transfer wheel 252. A swing wheel 254 is assembled such that it is swingable and rotatable relative to the main plate 102. A swing wheel spring 256 is provided to press the swing wheel 254 against the main plate 102. The swing wheel spring 256 is integrally formed with the date indicator maintaining plate 210.

A calendar corrector wheel 258 is rotatably assembled relative to the main plate 102. The first calendar corrector transfer wheel 250 is configured to rotate integrally with the winding stem 110 by rotating the winding stem 110 positioned at the first click position. By positioning the winding stem 110 at the first click position and rotating the winding stem 110 in one direction, the second calendar corrector transfer wheel 252 rotates in response to the rotation of the first calendar corrector transfer wheel 250. Then, the swing wheel 254 swings in a direction in which it approaches the gear of the date indicator 212, and the gear of the swing wheel 254 engages the gear of the date indicator 212, allowing correction of the date indicator 212. By positioning the winding stem 110 at the first click position and rotating the winding stem 110 in the other direction, the second calendar corrector transfer wheel 252 rotates in response to the rotation of the first calendar corrector transfer wheel 250. Then, the swing wheel 254 swings in a direction in which it moves away from the gear of the date indicator 212, and the gear of the swing wheel 254 can rotate the calendar corrector wheel 258.

A column wheel 260 is rotatably provided relative to the cylindrical outer circumference of the hour wheel 150. The column wheel 260 includes a cam outer circumference 260a and a column wheel gear 260b. The column wheel gear 260b includes, for example, fourteen teeth. The column wheel gear 260b is assembled such that it is intermittently driven by the two column wheel fingers 236a and 236b. The column wheel gear 260b is configured to intermittently advance by two teeth in 24 hours. This is, the column wheel 260 is configured to make one revolution in seven days. A column wheel jumper 262 is configured to regulate the rotation of the column wheel gear 260b. The column wheel jumper 262 is integrally formed with the date indicator maintaining plate 210.

The cam outer circumference 260a of the column wheel 260 is formed such that the radius from the center of rotation to the outer circumference changes along the circumferential direction. The cam outer circumference 260a is formed such that its radius smoothly increases from the minimum value RMIN to the maximum value RMAX in the circumferential direction along the cam outer circumference 260a. A stepped portion where the radius of the cam outer circumference 260a abruptly changes is located between the position where the radius of the cam outer circumference 260a becomes the maximum value RMAX and the position where the radius becomes minimum value RMIN. The cam outer circumference 260a uniformly expands from the minimum radius portion closest to the center of rotation of the column wheel 260 to the maximum radius portion of the column wheel 260 to form a spirally-curved contour in which the portion where the radius of the cam outer circumference 260a becomes the maximum value RMAX is connected to the portion where the radius becomes the minimum value RMIN. As a result, the cam outer circumference 260a is built into a shape similar to a cam surface of a so-called “swing cam”. Thus formed cam outer circumference 260a allows a member in contact with the cam outer circumference 260a to make a smooth swing movement. The actual shape of the cam outer circumference 260a may be formed of a combination of a plurality of straight lines, or may be formed of a combination of at least one curved line and at least one straight line. In this case, the curved line may be arcuate, cycloid, involute or the like.

A hammer 266 is swingably assembled relative to the small day indicator support 222 and the small day indicator support seating 220. The center of rotation of the hammer 266 can be located approximately in the six o'clock direction of the movement. The center of rotation of the hammer 266 is located between the outer circumference of the column wheel gear 260b and the addendum circle of the date indicator 212. The hammer 266 includes a cam contact portion 266c and a hammer gear 266d. The hammer gear 266d is formed as a “partial gear” with a groove angle of 20 to 40 degrees with reference to the center. The hammer gear 266d can be located approximately between the five o'clock and six o'clock directions of the movement. The cam contact portion 266c is configured to be in contact with the cam outer circumference 260a of the column wheel 260. As described later with regard to variations of the first embodiment of the time piece with a fan-shaped hand-motion display mechanism according to the invention, the hammer 266 can be provided with a plurality of hammer gears. For example, the hammer 266 can be configured to include the cam contact portion 266c, the first hammer gear 266d and a second hammer gear 266f.

A small day indicator 270 is rotatably assembled relative to the small day indicator support 222 and the main plate 102. The hammer gear 266d is configured to engage the gear of the small day indicator 270. A hammer return spring 272 is assembled to the small day indicator support seating 220 such that the hammer return spring 272 always applies a one-directional rotational force on the small day indicator 270. The hammer return spring 272 is disposed between the small day indicator support 222 and the small day indicator support seating 220. The hammer return spring 272 includes an elastically deformable return spring 272b and a return spring gear 272d. The return spring gear 272d is configured as a “partial gear” with a groove angle of 20 to 40 degrees with reference to the center. The return spring gear 272d is configured to engage the gear of the small day indicator 270. The hammer return spring 272 can be disposed approximately between the two o'clock and five o'clock directions of the movement. The hammer return spring 272 may also be formed of a spiral spring.

The hammer return spring 272 may be replaced with biasing means for pushing the cam contact portion 266c of the hammer 266 to the cam outer circumference 260a of the column wheel 260. The biasing means always applies a one-directional rotational force on the small day indicator 270. The biasing means is preferably formed of, for example, a leaf spring, U-shaped spring, wire spring or coil spring. Alternatively, the biasing means may be integrally formed with the hammer 266. With such a configuration, the rotation of the column wheel 260 swings the hammer 266 within a predetermined range of angles. As a result, the small day indicator 270 rotates within a predetermined range of angles.

A small day hand 276 is fixed to the hand attachment portion of the small day indicator 270. The center of rotation of the small day indicator 270 is located at a position approximately in the five o'clock direction of the timepiece. The center of rotation of the small day indicator 270 is located between the outer circumference of the column wheel gear 260b and the addendum circle of the date indicator 212. The center of rotation of the small day indicator 270 may also be located in other directions, such as six o'clock, seven o'clock, and nine o'clock directions. The center of rotation of the small day indicator 184 is preferably located at a position close to the addendum circle of the date indicator 212. Thus configured small day indicator 270 provides a large and very easy-to-see day display. This configuration also provides an easy-to-see date display.

Although the above embodiment has been illustrated and described based on the configuration in which the small day indicator 270 displays information on “day” by providing the column wheel gear 260b having fourteen teeth and also providing the hammer 266, the number of teeth of the column wheel gear may be seven or twenty one. That is, to display the “seven days” using a column wheel gear, the number of teeth of the column wheel gear is required to be an integer multiple of seven (i.e., seven, fourteen, twenty-one, twenty-eight and the like). In other words, to selectively display “X pieces of information” using a column wheel gear, the number of teeth of the column wheel gear is required to be an integer multiple of X (i.e., nX, where n is a positive integer of 1 or greater). For example, to display the “seven days” using a column wheel gear, the number of teeth of the column wheel gear is required to be an integer multiple of seven (i.e., seven, fourteen, twenty-one, twenty-eight and the like). As a variation, to display “six days” using a column wheel gear, the number of teeth of the column wheel gear is required to be an integer multiple of six (i.e., six, twelve, twenty-four and the like).

(1.3) Operation of the First Embodiment

The operation of a regular hand motion will be described with reference to the first embodiment of the timepiece with a fan-shaped hand-motion display mechanism according to the invention. Referring to FIGS. 1 to 5, a motor drive signal outputted from the integrated circuit 124 causes the coil block 134 to magnetize the stator 136 and then rotate the rotor 138. The rotor 138 rotates, for example, 180 degrees per second. In response to the rotation, of the rotor 138, the second wheel & pinion 142 rotates via the fifth wheel & pinion 140. The secondhand 160 attached to the second wheel & pinion 142 displays time information, specifically, “second.” In response to the rotation of the second wheel & pinion 142, the third wheel & pinion 144 rotates.

In response to the rotation of the third wheel & pinion 144, the center wheel & pinion 146 rotates. The minute hand 162 attached to the center wheel & pinion 146 displays time information, specifically, “minute.” The sliding mechanism provided on the center wheel & pinion 146 allows the minute hand 162 and hour hand 164 to rotate by rotating the winding stem 110 while the train wheel setting lever 152 regulates the gear of the fifth wheel & pinion 140 to stop the second hand 160 for time setting. In response to the rotation of the center wheel & pinion 146, the minute wheel 148 rotates. In response to the rotation of the minute wheel 148, the hour wheel 150 rotates. The hour hand 164 attached to the hour wheel 150 displays time information, specifically, “hour.” In response to the rotation of the hour wheel 150, the date indicator driving wheel 230 rotates, and the date finger 234 rotates the date indicator 212 clockwise by one tooth only once a day.

The rotation of the date indicator driving wheel 230 causes the column wheel fingers 236a and 236b to rotate the column wheel gear 260b by two teeth per day. That is, the column, wheel gear 260b makes 1/7 revolution once a day. The rotation of the column wheel gear swings the cam contact portion of the hammer 266 in contact with the outer circumference 260a of the column wheel 260. The gear of the hammer 266 engages the gear of the small day indicator 270. The rotation of the column wheel 260 rotates the hammer 266, thereby rotating the small day indicator 270. The hammer return spring 272 applies a force to the small day indicator 270 in the counterclockwise direction when viewed in FIG. 1. The force of the hammer return spring 272 presses the cam contact portion of the hammer 266 against the cam outer circumference of the column wheel 260. The cam outer circumference 260a of the column wheel 260 is formed such that the radius from the center of rotation of the column wheel 260 changes along the circumferential direction. That is, the radius from the center of rotation of the column wheel 260 continuously increases in the counterclockwise circumferential direction up to the maximum value, next to which the initial position where the radius becomes the minimum value is located.

In FIG. 1, the cam contact portion of the hammer 266 is in contact with a first position close to the location where the radius of the cam outer circumference 260a is the minimum value. Therefore, the small day indicator 270 is situated at a first position where the small day hand 276 has rotated counterclockwise by the greatest amount within the range that the small day hand 276 can provide indication. At this position, the small day hand 276 points the character “MON”, which represents Monday printed-on the dial. Then, when the column wheel 260 rotates, the small day indicator 270 rotates clockwise from the above position to a second position. At this position, the small day hand 276 points the character “TUE” (not shown), which represents Tuesday printed on the dial. Similarly, when the column wheel 260 sequentially rotates, the small day hand 276 can point Wednesday, Thursday, Friday, Saturday and Sunday printed on the dial.

At a position where Sunday is pointed, the cam contact portion of the hammer 266 is in contact with a seventh position where the radius of the cam outer circumference 260a has the seventh value. When the column wheel 260a further rotates, the cam contact portion of the hammer 266 rotates beyond the portion where the radius of the cam outer circumference 260a is the maximum value, and the small day hand 276 that has pointed the character “SUN”, which represents Sunday, will point the character “MON”, which represents Monday. Thus, the radius of the cam outer circumference 260a is configured to be directly proportional to the angle that the cam rotates in the circumferential direction. As a result, when the column wheel 260 rotates, the small day hand 276 can sequentially point the seven characters on the dial and display from Monday to Sunday. In this case, by providing one idle wheel (idler) between the hammer 266 and the small day indicator 270, the rotational direction of the small day indicator 270 can be reversed.

(1.4) Description of the Exterior of the Timepiece with a Fan-Shaped Hand-Motion Display Mechanism

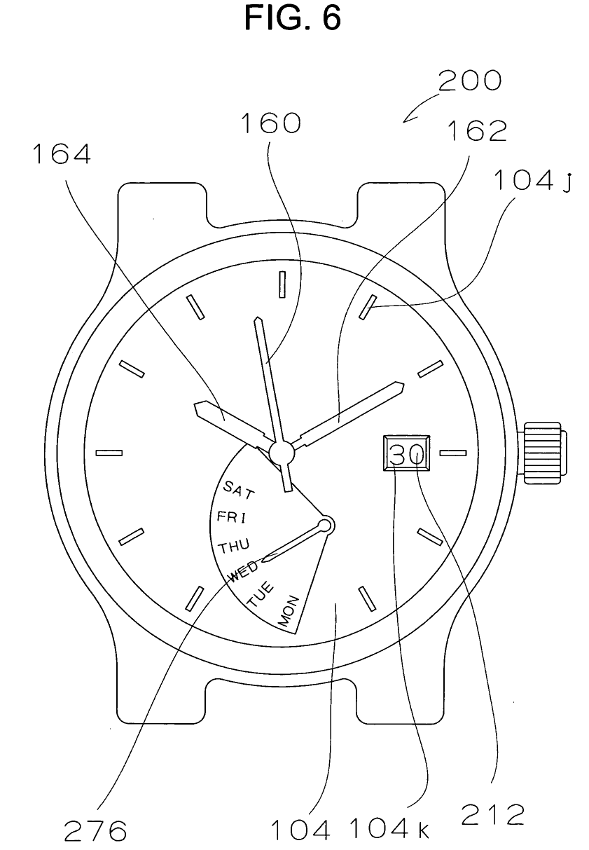

The structure of a display portion of a complete assembly (wristwatch with a case) 200 of a timepiece with a fan-shaped hand-motion display mechanism to which the invention is applied will be described. Referring to FIG. 6, typeset letters or letter-type codes 104j are provided along the periphery of the dial 104. Characters or symbols representing the seven days are provided between the five o'clock and eight o'clock directions on the dial 104. In the structure shown in FIG. 6, alphabetical characters “MON”, “TUE”, “WED”, “THU”, “FRI”, “SAT” and “SUN” are provided. The characters representing the seven days may be other language characters, or may be Roman numerals, such as “I”, “II” and “III.”

Alternatively, a plurality of characters or symbols, such as “MON:*1”, “TUE:*2”, . . . , “SUN:*7”, may be used, where “*1”, “*2”, . . . , “*7” denote Monday, Tuesday, . . . , Sunday expressed in other languages, respectively. With such a configuration, one timepiece can be used in a number of countries. That is, if the “*1”, “*2”, . . . , “*7” represent Japanese characters, timepieces having the above multiple characters can be used in countries where either English or Japanese is used. Current time will be provided through the positional relationship between the hour hand 164, minute hand 162 and second hand 160 and the typeset letters or letter-type codes 104j on the dial 104.

Current date will be provided through the date character on the date indicator 212 situated under a window 104k disposed on the three o'clock side of the dial 104. Current day will be provided through the positional relationship between the small day hand 276 and the characters representing the seven days. The timepiece with a fan-shaped hand-motion display mechanism shown in FIG. 6 currently displays “30th”, “WED” and “10:09:58.” In the timepiece with a fan-shaped hand-motion display mechanism shown in FIG. 6, the tip of the small day hand 276 will point directions approximately from six o'clock to ten o'clock.

(1.5) First Variation of the First Embodiment

A first variation of the first embodiment of the timepiece with a fan-shaped hand-motion display mechanism according to the invention will be described. In the following description, differences between the first variation of the invention and the first embodiment of the invention will be mainly described. Therefore, for those on which no description is given below, the description of the first embodiment of the invention is hereby incorporated. The first variation of the invention is configured such that the center of rotation of a display member or indicator hand of the fan-shaped hand-motion display mechanism is located between the seven o'clock and eight o'clock directions of the movement.

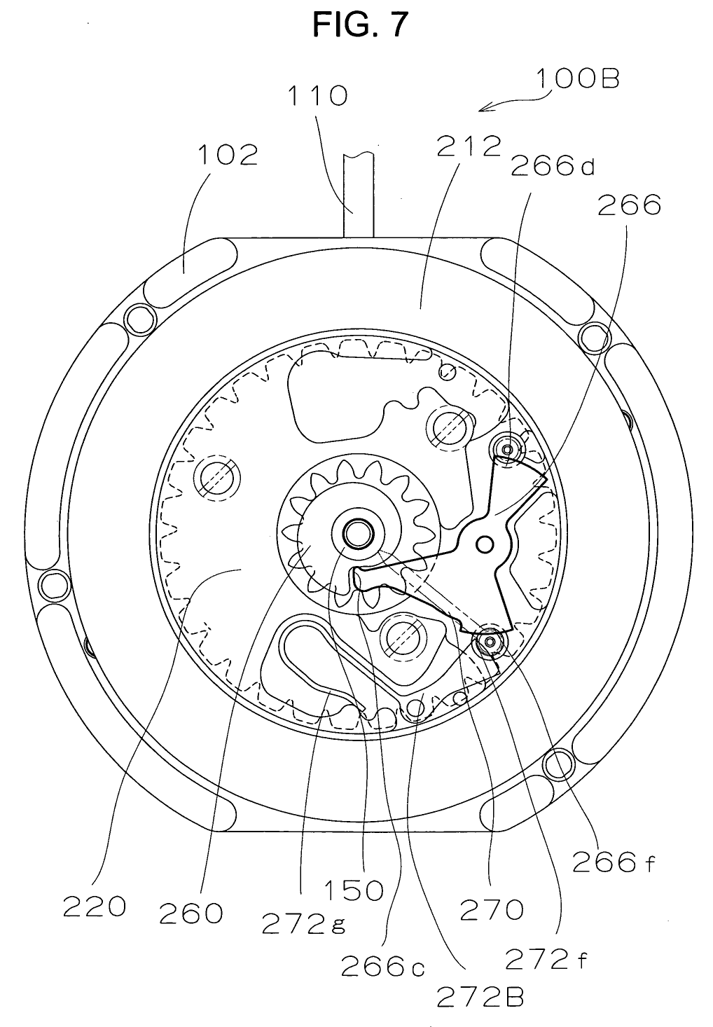

Referring FIG. 7, in the first variation of the invention, a movement 100B has the hammer 266 swingably assembled relative to the small day indicator support 222 and the small day indicator support seating 220. The center of rotation of the hammer 266 can be located approximately in the six o'clock direction of the movement. The center of rotation of the hammer 266 is located between the outer circumference of the column wheel gear 260b and the addendum circle of the date indicator 212. The hammer 266 includes the cam contact portion 266c, the first hammer gear 266d and the second hammer gear 266f. The first hammer gear 266d is configured as a “partial gear” with a groove angle of 20 to 40 degrees with reference to the center. The first hammer gear 266d can be disposed approximately between the five o'clock and six o'clock directions of the movement. The second hammer gear 266f is configured as a “partial gear” with a groove angle of 20 to 40 degrees with reference to the center. The second hammer gear 266f can be disposed approximately between the seven o'clock and eight o'clock directions of the movement.

The small day indicator 270 is rotatably assembled relative to the small day indicator support 222 and the main plate 102. The second hammer gear 266f is configured to engage the gear of the small day indicator 270. A hammer return spring 272B is assembled to the small day indicator support seating 220 such that the hammer return spring 272B always applies a one-directional rotational force on the small day indicator 270. The hammer return spring 272B is disposed between the small day wheel support 222 and the small day indicator support seating 220. The hammer return spring 272B includes an elastically deformable return spring 272f and a return spring gear 272g. The return spring gear 272f is configured as a “partial gear” with a groove angle of 20 to 40 degrees with reference to the center. The return spring gear 272f is configured to engage the gear of the small day indicator 270. The elastic force of the hammer return spring 272B can press the cam contact portion 266c of the hammer 266 against the cam outer circumference 260a of the column wheel 260. The hammer return spring 272B can be disposed approximately between the seven o'clock and ten o'clock directions of the movement. The hammer return spring 272B may also be formed of a spiral spring.

The center of rotation of the small day indicator 270 can be located approximately between the seven o'clock and eight o'clock directions of the timepiece. The center of rotation of the small day indicator 270 is located between the outer circumference of the column wheel gear 260b and the addendum circle of the date indicator 212. The center of rotation of the small day indicator 270 may also be located in other directions, such as six o'clock, seven o'clock, and nine o'clock directions. The center of rotation of the small day indicator 270 is preferably located at a position, close to the addendum circle of the date indicator 212. With such a configuration, the small day indicator 270 may be disposed such that the gear of the small, day indicator 270 engages the second hammer gear 266f, or may be disposed such that the gear of the small day indicator 270 engages the first hammer gear 266d.

With this configuration, the small day indicator 270 can be disposed at either of the two pre-designed positions in the movement. Furthermore, by assigning various specification values to the position of the center of rotation of the small day indicator 270, the number of gears provided on the small day indicator 270, the position of the center of rotation of the hammer 266, the position of the gear of the hammer 266, and the number of gears provided on the hammer 266, the small day indicator 270 can be disposed at either of a plurality of positions in the movement. For example, two or three, or even greater numbers of positions for the center of rotation of the hammer 266 can be located between the outer, circumference of the column wheel gear 260b and the addendum circle of the date indicator 212. In this configuration, two or three, or even greater numbers of positions for the center of rotation of the small day indicators 270 can be located between the outer circumference of the column wheel gear 260b and the addendum circle of the date indicator 212 such that those positions for the center of rotation of the small day indicators 270 correspond to respective positions for the center of rotation of the hammer 266.

That is, it is advantageous that the movement is pre-designed to have one or more positions for the center of rotation of the small day indicator 270 and associated parts, such as the main plate 102, small day indicator support 222 and small day indicator support seating 220, are provided with bearings, guides and the like corresponding to the respective positions of the center of rotation of the small day indicator 270. Similarly, it is advantageous that the movement is pre-designed to have one or more positions for the center of rotation of hammer 266 and associated parts, such as the main plate 102, small day indicator support 222 and small day indicator support seating 220, are provided with bearings, guides and the like corresponding to the respective positions of the center of rotation of the hammer 266. It is advantageous that the movement is pre-designed to have one or more positions where the hammer return spring 272 (272B) is assembled and associated parts, such as the main plate 102, small day indicator support 222 and small day indicator support seating 220, are provided with shafts, guides, positioners of the spring tip and the like corresponding to the respective assembling positions.

With such a configuration, the fan-shaped hand-motion display mechanism can be disposed at a plurality of positions in the movement without changing the shapes and dimensions of the associated parts, such as the main plate 102, small day indicator support 222, small day indicator support seating 220, and hammer 266.

Furthermore, by preparing one type of hammer return spring and changing its location or assembling it upside-down, the fan-shaped hand-motion display mechanism can be disposed at a plurality of positions in the movement without changing the shape and dimension of the hammer return spring. Therefore, by locating the center of rotation of the small day indicator 270 in various directions without changing the shapes and dimensions of the associated parts, complete assemblies with various exteriors can be realized using one type of movement. That is, by applying the configuration of the invention, the position where the fan-shaped hand-motion display mechanism is disposed can be located at various locations in one movement without changing associated parts or with minimum change to associated parts, allowing substantially increased design freedom.

In the invention, since the center of rotation of the column wheel 260 is situated at the center of the movement, the center of rotation of the small day indicator 270 may be located in any direction throughout the circumference of the movement (at various locations, such as in one o'clock direction, two o'clock direction, . . . , twelve o'clock direction, or intermediate directions therebetween), or the center of rotation of the hammer 266 may be located in any direction throughout the circumference of the movement.

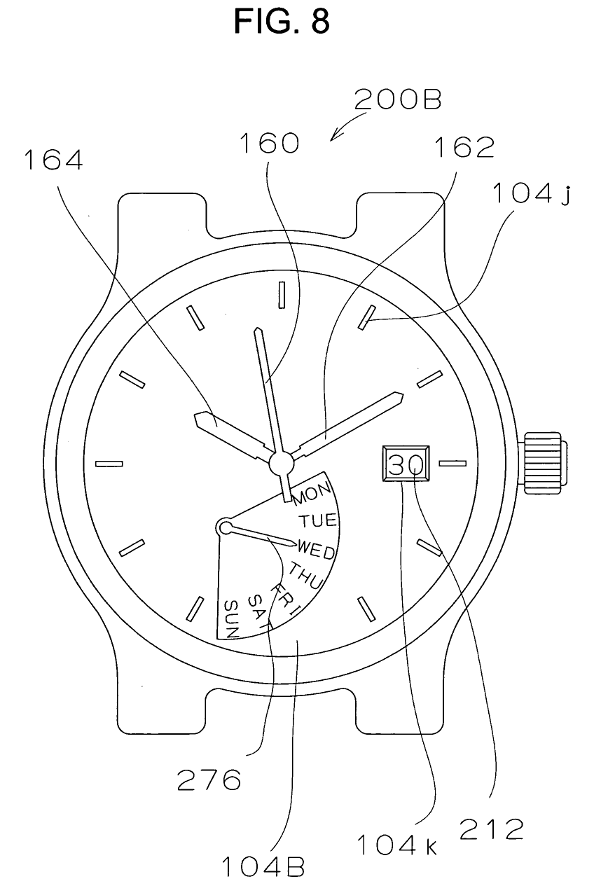

Referring to FIG. 8, in the first variation of the first embodiment of the timepiece with a fan-shaped hand-motion display mechanism according to the invention, the structure of a display portion of a complete assembly (wristwatch with a case) 200B of the timepiece will be described. Typeset letters or letter-type codes 104j are provided along the periphery of a dial 104B. Characters or symbols representing the seven days are provided between the five o'clock and eight o'clock directions on the dial 104B. In the structure shown in FIG. 8, alphabetical characters “MON”, “TUE”, “WED”, “THU”, “FRI”, “SAT” and “SUN” are provided.

Current date will be provided through the date character on the date indicator 212 situated under the window 104k disposed on the three o'clock side of the dial 104B. Current day will be provided through the positional relationship between the small day hand 276 and the characters representing the seven days. The timepiece with a fan-shaped hand-motion display mechanism shown in FIG. 8 currently displays “30th”, “WED” and “10:09:58.” In the timepiece with a fan-shaped hand-motion display mechanism shown in FIG. 8, the tip of the small day hand 276 will point directions approximately from two o'clock to seven o'clock.

(1.6) Second Variation of the First Embodiment

A second variation of the first embodiment of the timepiece with a fan-shaped hand-motion display mechanism according to the invention will be described. In the following description, differences between the second variation of the invention and the first embodiment of the invention will be mainly described. Therefore, for those on which no description is given below, the description of the first embodiment of the invention is hereby incorporated. The second variation of the invention is configured such that the center of rotation of a display hand of the fan-shaped hand-motion display mechanism is located in the twelve o'clock direction of the movement.

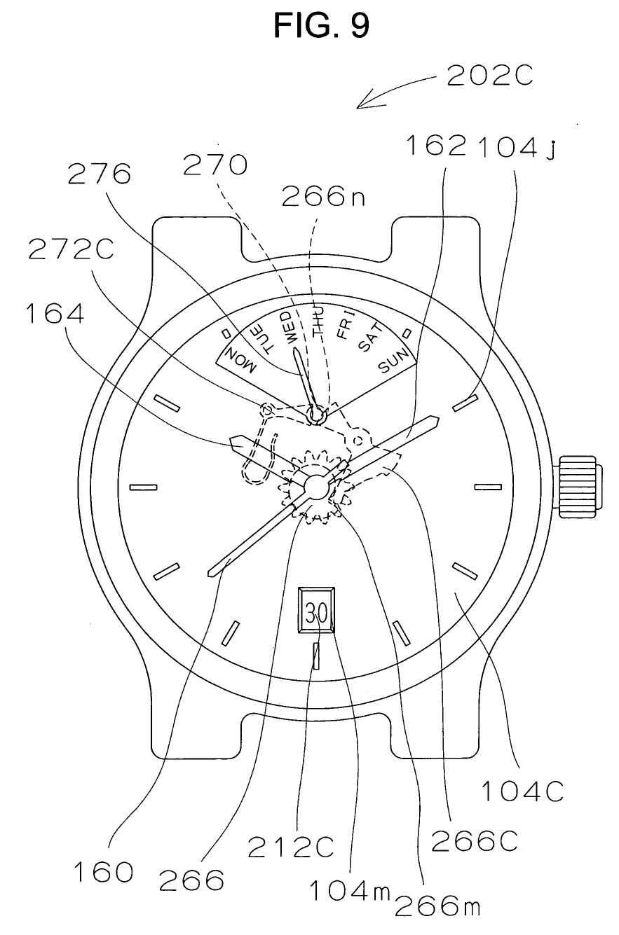

Referring to FIG. 9, in the second variation of the invention, the structure of a display portion of a complete assembly (wristwatch with a case) 200C of the timepiece is described. Typeset letters or letter-type codes 104j are provided along the periphery of a dial 104C. Characters or symbols representing the seven days are provided between the ten o'clock and two o'clock directions on the dial 104C. In the structure shown in FIG. 9, alphabetical characters “MON”, “TUE”, “WED”, “THU”, “FRI”, “SAT” and “SUN” are provided.

Current date will be provided through the date character on a date indicator 212C situated under the window 104m disposed on the six o'clock side of the dial 104C. Current day will be provided through the positional relationship between the small day hand 276 and the characters representing the seven days. The timepiece with a fan-shaped hand-motion display mechanism shown in FIG. 9 currently displays “30th”, “WED” and “10:09:38.” In the timepiece with a fan-shaped hand-motion display mechanism shown in FIG. 9, the tip of the small day hand 276 will point directions approximately from eleven o'clock to one o'clock.

In the movement (not shown) of the timepiece accommodated in the complete assembly (wristwatch with a case) 200C, the center of rotation of a hammer 266C can be located approximately in the three o'clock direction of the movement. The hammer 266C includes a cam contact portion 266m and a hammer gear 266n. The hammer gear 266n is configured as a “partial gear” with a groove angle of 20 to 40 degrees with reference to the center. The hammer gear 266n can be disposed approximately between the twelve o'clock and one o'clock directions of the movement. The hammer gear 266n is configured to engage the gear of the small day indicator 270. A hammer return spring 272C can be disposed approximately between the eight o'clock and twelve o'clock directions of the movement. The elastic force of the hammer return spring 272C can press the cam contact portion 266m of the hammer 266C against the cam outer circumference 260a of the column wheel 260.

### (2) Second Embodiment

A second embodiment of a timepiece with a fan-shaped hand-motion display mechanism according to the invention will be described. In the following description, differences between the second embodiment of the invention and the first embodiment of the invention will be mainly described. Therefore, for those on which no description is given below, the description of the first embodiment of the invention is hereby incorporated. The second embodiment of the invention is a mechanical timepiece with a self-winding mechanism and a day/date function.

(2.1) Structure of the Front Side of the Movement

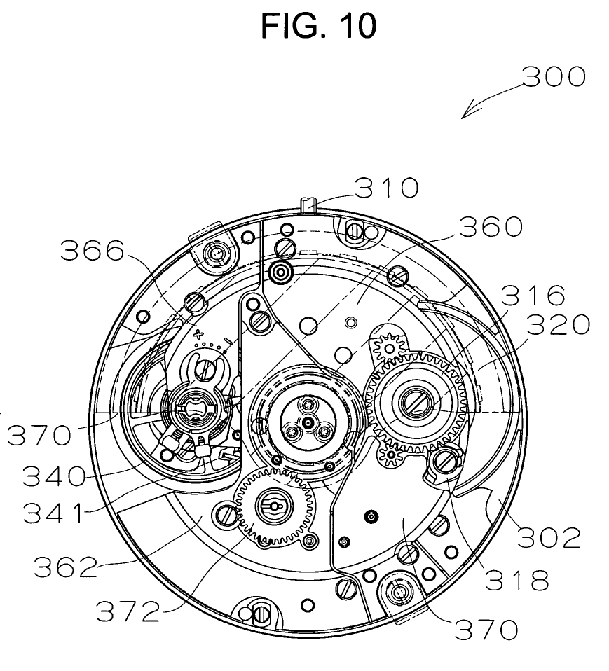

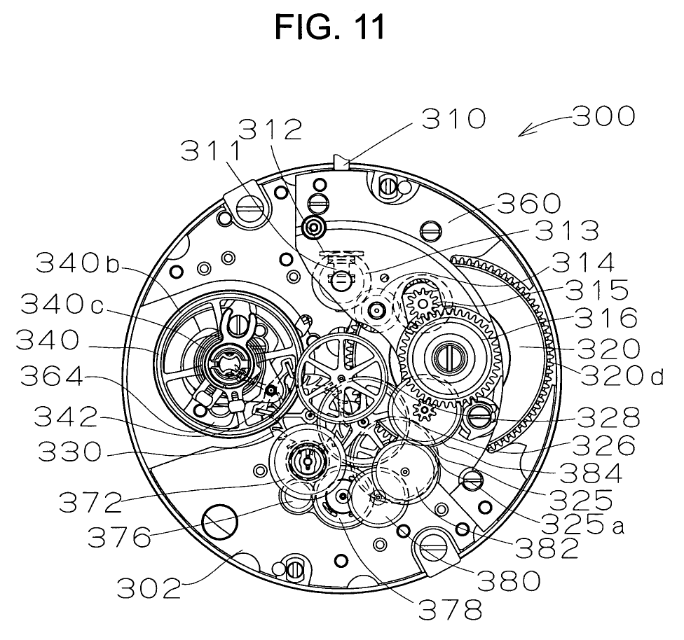

The schematic structure of the front side of the movement will be described below. Referring to FIGS. 10 and 11, in a movement 300, a winding stem 310 is rotatably assembled in a winding stem guide hole of the main plate 102. An escapement/speed governor including a balance with hairspring 340, an escape wheel & pinion 330 and a pallet fork 342, and a front train wheel including a second wheel & pinion 328, a third wheel & pinion 326, a center wheel & pinion 325 and a movement barrel 320 are disposed on the “front sides of the movement 300. A switching device including a setting lever, yoke, yoke spring and yoke holder is disposed on the “back side” or “front side” of the movement 300. On the “front side” of the movement 300 are disposed a barrel bridge 360 that rotatably supports the upper part of the shaft of the movement barrel 320 and the upper part of the shaft of the center wheel & pinion 325, a train wheel bridge 362 that rotatably supports the upper part of the shaft of the third wheel & pinion 326, the upper part of the shaft of the second wheel & pinion 328 and the upper part of the shaft of the escape wheel & pinion 330, a pallet bridge 364 that rotatably supports the upper part of the shaft of the pallet fork 342, and a balance bridge 366 that rotatably supports the upper part of the shaft of the balance with hairspring 340.

(2.2) Self-Winding Mechanism.

The structure of the self-winding mechanism will be described. Referring to FIG. 10, the self-winding mechanism includes an oscillating weight 370, a first intermediate wheel 372 that rotates in response to the rotation of the oscillating weight 370, a second intermediate wheel 376 that rotates in response to the rotation of the first intermediate wheel 372, a rocker setting wheel 378 including a rocker pinion that rotates in one direction in response to the rotation of the first and second intermediate wheels 372 and 376, a first transfer wheel 380 that rotates in response to the rotation of the rocker setting wheel 378, a second transfer wheel 382 that rotates in response to the rotation of the first transfer wheel 380, and a third transfer wheel 384 that rotates in response to the rotation of the second transfer wheel 382. As the rotational direction of the rocker pinion of the rocker setting wheel 378 is fixed independent of the rotational direction of the oscillating weight 370, a ratchet wheel 316 can be rotated only in one direction via the rotation of the first transfer wheel 380, second transfer wheel 382 and third transfer wheel 384 in response to the rotation of the rocker pinion. The rotation of the ratchet wheel 316 winds up a mainspring in the movement barrel 320.

(2.3) Escapement/Speed Governor and Front Train Wheel

The structure of the escapement/speed governor and front train wheel will be described. Referring to FIG. 11, by rotating the winding stem 310 when it is in the zeroth click position, a winding pinion 312 rotates in response to the rotation of a clutch wheel 311. A crown wheel 313 is configured to rotate in response to the rotation of the winding pinion 312. A crown transfer wheel 314 is configured to rotate in response to the rotation of the crown wheel 313. A ratchet sliding wheel 315 is configured to rotate in response to the rotation of the crown transfer wheel 314. The ratchet wheel 316 rotates in response to the rotation of the ratchet sliding wheel 315. The rotation of the ratchet wheel 316 winds up a mainspring accommodated in the movement barrel 320.

The center wheel & pinion 325 is configured to rotate in response to the rotation of the movement barrel 320. The third wheel & pinion 326 is configured to rotate in response to the rotation of the center wheel & pinion 325. The second wheel & pinion 328 is configured to make one revolution in one minute in response to the rotation of the third wheel & pinion 326. The escape-wheel & pinion 330 is configured to rotate in response to the rotation of the second wheel & pinion 328 under the control of the pallet fork 342. The escapement/speed governor includes the balance with hairspring 340, escape wheel & pinion 330 and pallet fork 342. The balance with hairspring 340 includes a balance staff, balance wheel 340b and hairspring 340c. The second wheel & pinion 328 makes one revolution in one minute via the rotation of the third wheel & pinion 326 in response to the rotation of the center wheel & pinion 325. A second hand attached to the second wheel & pinion 328 displays second.”

A minute indicator makes one revolution in one hour via the rotation of the center wheel & pinion 325 and the third wheel & pinion 326 in response to the rotation of the movement barrel 320. A minute hand attached to the minute indicator displays “minute.” An hour wheel (not shown) makes one revolution in twelve hours via a minute wheel (not shown) in response to the rotation of the minute indicator. An hour hand attached to the hour wheel displays “hour.”

(2.4) Configuration of the Back Side of the Movement

The configuration and operation of the back side of the movement of the second embodiment according to the invention is the same as the configuration and operation of the back side of the movement 100 of the first embodiment according to the invention. In the movement 300, the hour wheel (not shown) includes an hour wheel gear that engages a minute pinion (not shown) and a date pinion that engages the date gear 232. The column wheel 260 is rotatably provided relative to the cylindrical outer circumference of the hour wheel. The fan-shaped hand-motion display mechanism includes the column wheel 260, hammer 266, small day indicator 270, hammer return spring 272, small day indicator support 222, and small day indicator support seating 220. The small day hand 276 attached to the small day indicator 270 can sequentially point the seven characters on the dial and display from Monday to Sunday. The movement 300 includes a date display mechanism (calendar mechanism), date corrector mechanism, day corrector mechanism and the like as in the movement 100 of the first embodiment according to the invention.

### (3) Application of the Configurations of the Invention

Although the embodiments of the timepiece with a fan-shaped hand-motion display mechanism according to the invention have been described above mainly based on the embodiments of wristwatches, the configurations of the timepiece with a fan-shaped hand-motion display mechanism according to the invention are applicable to clocks, pocket watches, large-sized timepieces or the like. The configurations of the timepiece with a fan-shaped hand-motion display mechanism according to the invention are also applicable to timepieces that operate under various principles of operation, such as mechanical, electrical, and electronic timepieces. Furthermore, the configurations of the fan-shaped hand-motion display mechanism in the time piece with a fan-shaped hand-motion display mechanism according to the invention are used to achieve a display device for displaying information other than days and dates. Examples of information that such other display devices display are months, years, six days, morning and afternoon, and chronograph (such as hour, minute). To manufacture such other display devices, the reduction ratio of the train wheel of the driving mechanism of the display device that is driven by the train wheel, such as hour wheel and the like, may be set to match the information to be displayed and the number of teeth of the column wheel gear may be set to match the information to be displayed.

The invention allows manufacture of a compact and thin timepiece with a fan-shaped hand-motion display mechanism having less number of components. The invention also allows manufacture of a timepiece with a fan-shaped hand-motion display mechanism in which the fan-shaped hand-motion display mechanism can be disposed at a plurality of positions in the movement. That is, by applying the configurations of the invention, the position where the fan-shaped hand-motion display mechanism is disposed can be located at various locations in one movement without changing associated parts or with minimum change to associated parts, allowing substantially increased design freedom of the timepiece.

The timepiece with, a fan-shaped hand-motion, display mechanism according to the invention has less number of components of the mechanism and is compact and thin. Furthermore, the timepiece with a fan-shaped hand-motion display mechanism according to the invention has greater freedom of the position where a fan-shaped hand-motion display mechanism is disposed and allows the position of a retrograde indicator hand being arbitrarily selected in the movement. Moreover, in the time piece with a fan-shaped hand-motion display mechanism according to the invention, the regular ring-shaped date indicator and the fan-shaped hand-motion display mechanism can be efficiently disposed in the movement.

What is claimed is:

1. A timepiece with a fan-shaped swing and display mechanism comprising:
a drive module for driving the timepiece;
a control module for controlling the operation of the drive module;
a train wheel that rotates based on the operation of the drive module;
a first display member that displays information on time, calendar and the like based on the rotation of the train wheel;
a column wheel having a cam outer circumference that is formed such that the radius from the center of rotation to the outer circumference continuously changes along the circumferential direction from the minimum to the maximum values, the column wheel rotating in response to the rotation of the train wheel;
a swingable hammer in contact with the outer circumference of the column wheel;
a small gear that rotates in response to the swing movement of the hammer;
a second display member that rotates in response to the rotation of the small gear and;
driving members for rotating the column wheel,
wherein the column wheel is configured to rotate, in response to the rotation of the train wheel, in a direction in which the distance between the center of rotation of the column wheel and the contact point between the column wheel and the hammer increases and;
the center of rotation of the column wheel coincides with the center of rotation of the first display member.

2. A timepiece according to claim 1, wherein the column wheel includes a column wheel gear that is rotated by the driving member and a column wheel jumper that regulates the rotation of the column wheel gear.

3. A timepiece according to claim 1, further comprising a hammer return spring configured to apply a rotational force on the hammer in a direction in which the hammer is pressed against the column wheel.

4. A timepiece according to claim 1, comprising an hour wheel that rotates in response to the rotation of the train wheel to display information on “hour”, wherein the column wheel is guided around the outer cylindrical circumference of the hour wheel and rotates around the center of rotation of the hour wheel.

5. A timepiece according to claim 1, comprising a date indicator driving wheel that rotates in response to the rotation of the train wheel, wherein the small gear is configured as a small day indicator and the column wheel gear makes 1/7 revolution once a day in response to the rotation of the date indicator driving wheel, allowing the display member provided on the small gear to swing in a fan shape to display “day.”

6. A timepiece according to claim 1, further comprising a date indicator driving wheel that rotates in response to the rotation of the train wheel and a date indictor that rotates in response to the rotation of the date indicator driving wheel to display information on “date”, wherein the intermittent driving member rotates in response to the rotation of the date indicator driving wheel.

7. A timepiece with a fan-shaped swing and display mechanism comprising a movement of the timepiece, the movement including:
a drive module for driving the timepiece;
a control module for controlling the operation of the drive module;
a train wheel that rotates based on the operation of the drive module;
a column wheel having a cam outer circumference that is formed such that the radius from the center of rotation to the outer circumference continuously changes along the circumferential direction from the minimum to the maximum values, the column wheel rotating in response to the rotation of the train wheel; and
driving members for rotating the column wheel,
wherein the movement is provided with one hammer assembling portion where a swingable hammer in contact with the outer circumference of, the column wheel can be assembled;
the movement is provided with two small gear assembling portions where a small gear that rotates in response to the swing movement of the hammer can be assembled;
the hammer is assembled at the hammer assembling portion;
the small gear is assembled at one of the two small gear assembling portions;
the column wheel is configured to rotate, in response to the rotation of the train wheel, in the direction in which the distance between the center of rotation of the column wheel and the contact point between the column wheel and the hammer increases, the movement further comprising:
a first display member that displays information on time, calendar and the like based on the rotation of the train wheel; and
a second display member that rotates in response to the rotation of the small gear,
wherein the center of rotation of the column wheel coincides with the center of rotation of the first display member.

8. A timepiece according to claim 7, wherein the movement is provided with a plurality of hammer assembling portions where the swingable hammer in contact with the outer circumference of the column wheel can be assembled;
the movement is provided with a plurality of small gear assembling portions where the small gear that rotates in response to the swing movement of the hammer can be assembled;
the hammer is assembled at one of the plurality of the hammer assembling portions; and
the small gear is assembled at one of the small gear assembling portions.

9. A timepiece according to claim 7, further comprising: a date indicator driving wheel that rotates in response to the rotation of the train wheel and a date indictor that rotates in response to the rotation of the date indicator driving wheel to display information on “date”, wherein the intermittent driving member is configured to rotate in response to the rotation of the date indicator driving wheel; the center of rotation of the small gear is located between the outer circumference of the column wheel gear and the addendum circle of the day indicator; and the center of rotation of the hammer is located between the outer circumference of the column wheel gear and the addendum circle of the day indicator.
